(19) United States
(12) Patent Application Publication
(10) Pub. No.: US 2012/0161551 A1
(43) Pub. Date: Jun. 28, 2012

(54) RELUCTANCE MOTOR

(75) Inventors: Yasuhiro MIYAMOTO, Fukuoka (JP); Motomichi Ohto, Fukuoka (JP); Tsuyoshi Higuchi, Nagasaki (JP)

(73) Assignees: Nagasaki University, Nagasaki-shi (JP); Kabushiki Kaisha Yaskawa Denki, Kitakyushu-shi (JP)

(21) Appl. No.: 13/311,549

(22) Filed: Dec. 6, 2011

(30) Foreign Application Priority Data
Dec. 28, 2010 (JP) 2010-293953

(51) Int. Cl. H02K 37/02

(52) U.S. Cl. 310/46

(57) ABSTRACT

A reluctance motor according to an aspect of an embodiment includes a stator and a mover. One of the stator and the mover includes a plurality of magnetic poles on which coils are wound. The other of the stator and the mover includes a magnetic segment that includes a directivity member of which the magnetization direction is regulated in a predetermined direction and that is embedded into a non-magnetic holder.

### CROSS-REFERENCE TO RELATED APPLICATION

This application is based upon and claims the benefit of priority of the prior Japanese Patent Application No. 2010-293953, filed on Dec. 28, 2010, the entire contents of which are incorporated herein by reference.

### FIELD

The embodiments discussed herein are directed to a reluctance motor.

### BACKGROUND

There has been known a conventional rotary reluctance motor that includes a cylindrical stator that has a plurality of magnetic poles wound with coils at its inner circumferential side and a columnar rotor that embeds therein magnetic segments of which the number is different from the number of the magnetic poles of the stator.

The rotary reluctance motor switches coils flowing electric currents and rotates the rotor by using an attractive force (reluctance torque) by which the magnetic poles that generate magnetic fluxes attract the magnetic segments. Moreover, there has also been known a linear reluctance motor that is made by linearly transforming a rotary reluctance motor.

The conventional technology has been known as disclosed in, for example, Japanese Laid-open Patent Publication No. 2006-246571 and Japanese Laid-open Patent Publication No. 2000-262037.

However, there is a problem in that the above conventional reluctance motor does not have sufficient torque and thrust.

For example, a rotary reluctance motor can improve a torque if an attractive force between salient poles of a stator and a rotor is improved. However, it is necessary to increase a volume of the salient pole to improve the attractive force.

For this reason, the improvement of the torque leads to a large-size motor. A linear reluctance motor also has the similar problem.

### SUMMARY

A reluctance motor according to an aspect of an embodiment includes a stator and a mover. One of the stator and the mover includes a plurality of magnetic poles on which coils are wound. The other of the stator and the mover includes a magnetic segment that includes a directivity member of which the magnetization direction is regulated in a predetermined direction and that is embedded into a non-magnetic holder.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings, wherein:

FIG. 1A is a top view of a reluctance motor according to a first embodiment;

FIG. 1B is an exploded view of a magnetic segment according to the first embodiment;

FIG. 2 is a cross-sectional view when the reluctance motor is incorporated into a linear slider according to the first embodiment;

FIG. 3A is a diagram illustrating an alternative example (1) of the magnetic segment according to the first embodiment;

FIG. 3B is a diagram illustrating an alternative example (2) of the magnetic segment according to the first embodiment;

FIG. 3C is a diagram illustrating an alternative example (3) of the magnetic segment according to the first embodiment;

FIG. 3D is a diagram illustrating an alternative example (4) of the magnetic segment according to the first embodiment;

FIG. 3E is a diagram illustrating an alternative example (5) of the magnetic segment according to the first embodiment;

FIG. 4A is a perspective view of a reluctance motor according to a second embodiment;

FIG. 4B is a front view of the reluctance motor according to the second embodiment;

FIG. 5A is a diagram illustrating an alternative example (1) of a magnetic segment according to the second embodiment;

FIG. 5B is a diagram illustrating an alternative example (2) of the magnetic segment according to the second embodiment;

FIG. 5C is a diagram illustrating an alternative example (3) of the magnetic segment according to the second embodiment;

FIG. 5D is a diagram illustrating an alternative example (4) of the magnetic segment according to the second embodiment;

FIG. 5E is a diagram illustrating an alternative example (5) of the magnetic segment according to the second embodiment; and

FIG. 6 is a diagram illustrating an alternative example (6) of the magnetic segment according to the second embodiment.

### DESCRIPTION OF EMBODIMENTS

Hereinafter, a linear reluctance motor will be explained as a first embodiment and a rotary reluctance motor will be explained as a second embodiment.

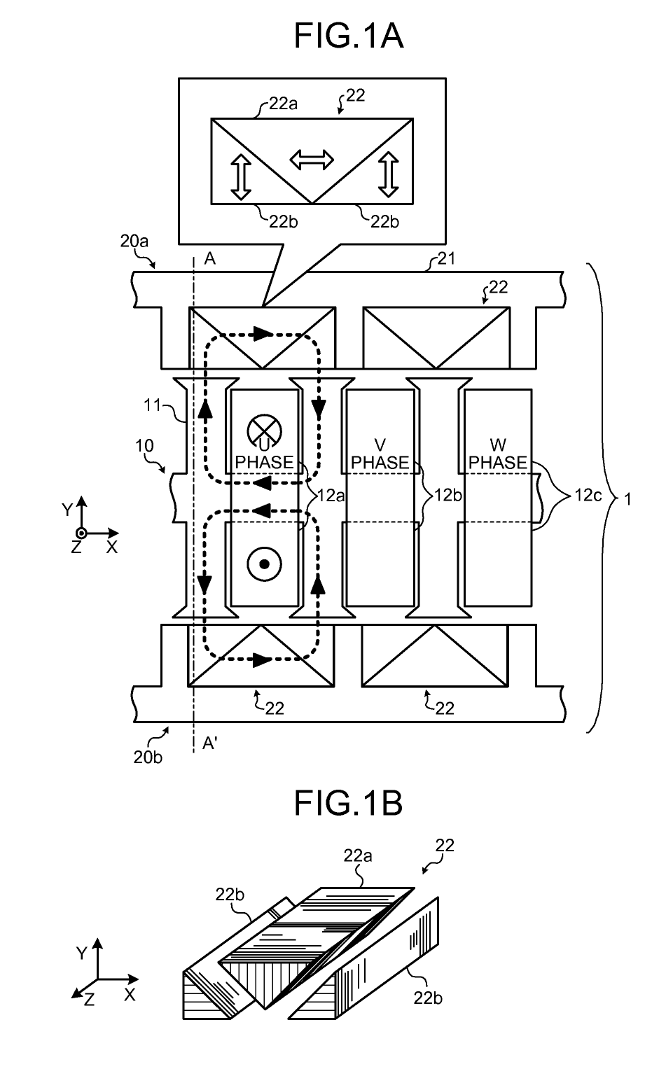

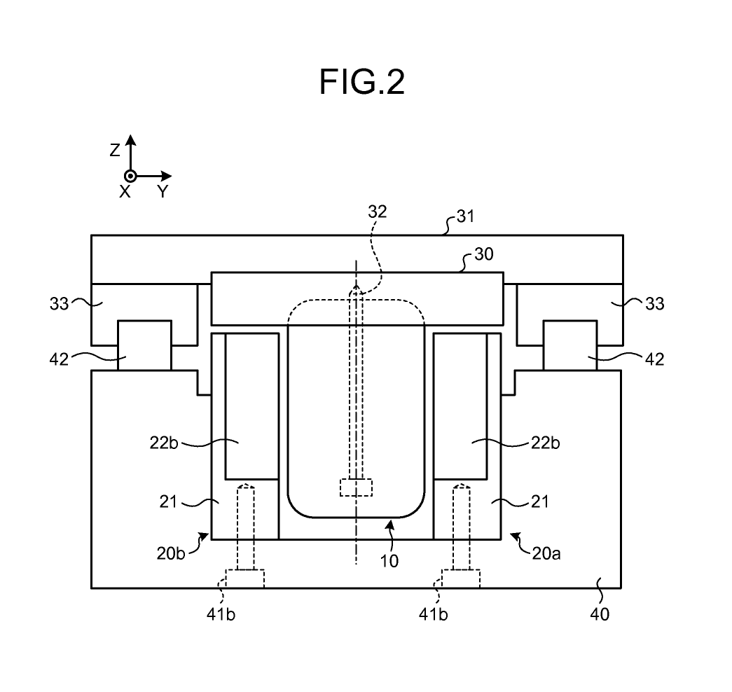

First, a reluctance motor according to the first embodiment is explained with reference to FIGS. 1A and 1B. FIG. 1A is a top view of a reluctance motor according to the first embodiment. FIG. 1B is an exploded view of a magnetic segment according to the first embodiment. Herein, only partial components of a reluctance motor 1 are illustrated from the viewpoint of simplification of explanation in FIG. 1A. The A-A′ line illustrated in FIG. 1A corresponds to FIG. 2 to be described below.

As illustrated in FIG. 1A, the reluctance motor 1 according to the first embodiment is a linear motor that is made by sandwiching a mover 10 between a stator 20a and a stator 20b. In this way, because attractive forces generated between two stators 20 (the stators 20a and 20b) and the mover 10 can be offset by sandwiching the mover 10 between the two stators 20, noises and vibrations can be reduced. In this case, the mover 10 is moved along X-axis illustrated in FIG. 1A.

The mover 10 includes a fish bone shaped core 11 and coils 12. In FIG. 1A, the coils 12 are indicated as a coil 12a, a coil 12b, and a coil 12c that respectively correspond to an U phase, a V phase, and a W phase. Meanwhile, these coils are collectively referred to as the coils 12.

The core 11 is formed by laminating thin-plate-shaped magnetic steel sheets along Z-axis. Then, the coils (the coil 12a, the coil 12b, and the coil 12c in FIG. 1A) of which the number is the same as the number of phases of the motor are wound on the core 11 around X-axis. Herein, salient portions of the core 11, which extend in positive and negative directions of Y-axis, correspond to magnetic poles.

In this case, when magnetic fluxes for phases are sequentially generated by sequentially switching the coils 12 of which the selected coil flows electric currents on the basis of a phase angle θ between the phases, the mover 10 obtains a thrust along X-axis. The case where electric currents are flowed into the U-phase coil 12a is illustrated in FIG. 1A. In this case, magnetic fluxes flowing in “dashed-arrow” directions illustrated in FIG. 1A are generated.

The stator 20a and the stator 20b include a comb-shaped non-magnetic holder 21 and magnetic segments 22. The comb-shaped non-magnetic holder 21 is provided with concaves for embedding therein the magnetic segments 22 at a predetermined interval. The magnetic segments 22 are embedded into the concaves. Because the stator 20a and the stator 20b have plane symmetry with respect to an XZ plane, the stator 20a will be explained below.

Herein, the reluctance motor 1 illustrated in FIG. 1A is a figure viewed from a positive direction of Z-axis. In this case, the shape of the concave of the comb-shaped non-magnetic holder 21 is a rectangle and also the shape of the magnetic segment 22 embedded into the concave is a rectangle.

A surface (hereinafter, “facing surface”) on which the stator 20a faces the mover 10 becomes a plane in a state where the magnetic segment 22 is embedded into the non-magnetic holder 21. A predetermined gap is provided between the facing surface of the stator 20a and the mover 10.

Herein, the reluctance motor 1 according to the first embodiment has a configuration that the magnetic segment 22 includes a “directivity member” of which the magnetization direction is regulated in a predetermined direction. For example, as illustrated in FIG. 1A, the magnetic segment 22 includes a directivity member 22a of which the magnetization direction is parallel to X-axis and directivity members 22b of which the magnetization direction is parallel to Y-axis. In the drawings including FIG. 1A, a magnetization direction is indicated by a “white-space double-headed arrow”.

A conventional magnetic segment is commonly made of one non-directivity member (non-directivity magnetic steel sheet, for example) of which the magnetization direction is not regulated. For this reason, the conventional magnetic segment has a problem in that magnetic fluxes flowed into a magnetic segment are easily cancelled and a phenomenon that the magnetic fluxes do not return to an inflow source occurs easily.

In other words, a reluctance motor that employs the conventional magnetic segment has a problem in that magnetic fluxes generated by coils are weakened when passing through magnetic segments to make the magnetization of the magnetic segments insufficient and thus the thrust of a mover cannot be sufficiently obtained.

To solve the problem, the reluctance motor 1 according to the first embodiment has a configuration that the route of a magnetic flux passing through the magnetic segment 22 is restricted by using the magnetic segment 22 including a “directivity member” as described above. As a result, the reluctance motor 1 according to the first embodiment can increase a thrust of the mover 10 without increasing the size of the magnetic segment 22.

In other words, as illustrated in FIG. 1A, the magnetic flux generated from the coil 12 of the mover 10 returns to the mover 10 by way of the directivity member 22b of which the magnetization direction is parallel to Y-axis, the directivity member 22a of which the magnetization direction is parallel to X-axis, and the directivity member 22b of which the magnetization direction is parallel to Y-axis (see the dashed-arrow line of FIG. 1A).

Then, the route of the magnetic flux passing through the magnetic segment 22 is restricted by the directivity members (the directivity member 22a and the directivity members 22b). In other words, the magnetic flux has a route according to the magnetization directions of the directivity members. Therefore, magnetic fluxes are not easily cancelled and a phenomenon by which the magnetic fluxes do not return to an inflow source does not occur easily.

The configuration of the magnetic segment 22 will be explained in detail with reference to FIG. 1B. The case where the magnetic segment 22 is constituted by three triangular prisms of which each is made by laminating directivity magnetic-steel sheets is illustrated in FIG. 1B.

As illustrated in FIG. 1B, the directivity member 22b is formed by laminating along Z-axis directivity magnetic-steel sheets of which the magnetization directions are parallel to Y-axis. Moreover, the directivity member 22a is formed by laminating along Z-axis directivity magnetic-steel sheets of which the magnetization directions are parallel to X-axis. In this case, the magnetization directions of the directivity members (the directivity member 22a and the directivity members 22b) are like directions illustrated in FIG. 1A (see the white-space double-headed arrow of FIG. 1A).

The shape of the directivity member 22a viewed from the positive direction of Z-axis is an isosceles triangle of which the base is parallel to X-axis. Moreover, the shape of the directivity member 22b viewed from the positive direction of Z-axis is a right-angled triangle of which the hypotenuse corresponds to the oblique line of the isosceles triangle. In this case, the directivity members (the directivity member 22a and the directivity members 22b) are triangular prisms of which each has the same cross sectional shape along Z-axis.

The magnetic segment 22 is obtained by attaching the adjacent sides (FIG. 1B) of the directivity members (the directivity member 22a and the directivity members 22b). As a result, the magnetic segment 22 forms therein the route along the magnetization directions of the directivity members (the directivity member 22a and the directivity members 22b).

The example has been illustrated in FIGS. 1A and 1B in which the magnetic segment 22 is constituted by three triangular prisms. However, the magnetic segment 22 may be constituted by one triangular prism and two quadratic prisms or may be constituted by one pentagonal prism and two triangular prisms.

Specifically, the magnetic segment 22 of FIG. 1A is divided into three parts by using division lines that link the midpoint of the lower side and the vertices of the upper side of the rectangular magnetic segment 22. However, the division line should not necessarily be a line that passes through a vertex.

For example, division lines that link points symmetrically provided on the upper side and the midpoint of the lower side of the magnetic segment 22 may be used. In this case, the shape of the directivity member 22a is a symmetric triangular prism and the shape of the two directivity members 22b is a quadratic prism.

Moreover, division lines that link the midpoint of the lower side and points provided on the left-hand and right-hand sides of the magnetic segment 22 away from the both ends of the upper side by a predetermined distance may be used. In this case, the shape of the directivity member 22a is a symmetric pentagonal prism and the shape of the two directivity members 22b is a triangular prism.

Next, the cross sectional shape of the reluctance motor 1 viewed from the A-A′ line illustrated in FIG. 1A is explained with reference to FIG. 2. FIG. 2 is a cross-sectional view when the reluctance motor 1 is incorporated into a linear slider according to the first embodiment. In this case, FIG. 2 corresponds to a case where the reluctance motor 1 illustrated in FIG. 1A is viewed from the positive direction of X-axis.

As illustrated in FIG. 2, an attachment base 30 is fitted into the central portion of the lower surface of a driving table 31 that is a movable body. The mover 10 is tightened by a fixing bolt 32 to be fixed to the attachment base 30. Moreover, a pair of linear guides 33 is provided near both lower ends of the driving table 31.

As illustrated in FIG. 2, a slider base 40 that is fixed to a floor or the like has a concave shape and is provided with the stator 20a and the stator 20b to sandwich the mover 10 therebetween from positive and negative directions of Y-axis. Herein, the stator 20a and the stator 20b are tightened by fixing bolts 41b to be fixed to the slider base 40.

As illustrated in FIG. 2, the directivity members 22b are placed at the mover side of the stator 20a and the stator 20b and the backside of the non-magnetic holder 21 is placed at the other side.

Moreover, a pair of guide rails 42 is provided near both upper ends of the slider base 40 at positions opposite to the pair of the linear guides 33. In other words, the driving table 31 is slidably supported by the guide rails 42 via the linear guides 33 in the X-axis direction.

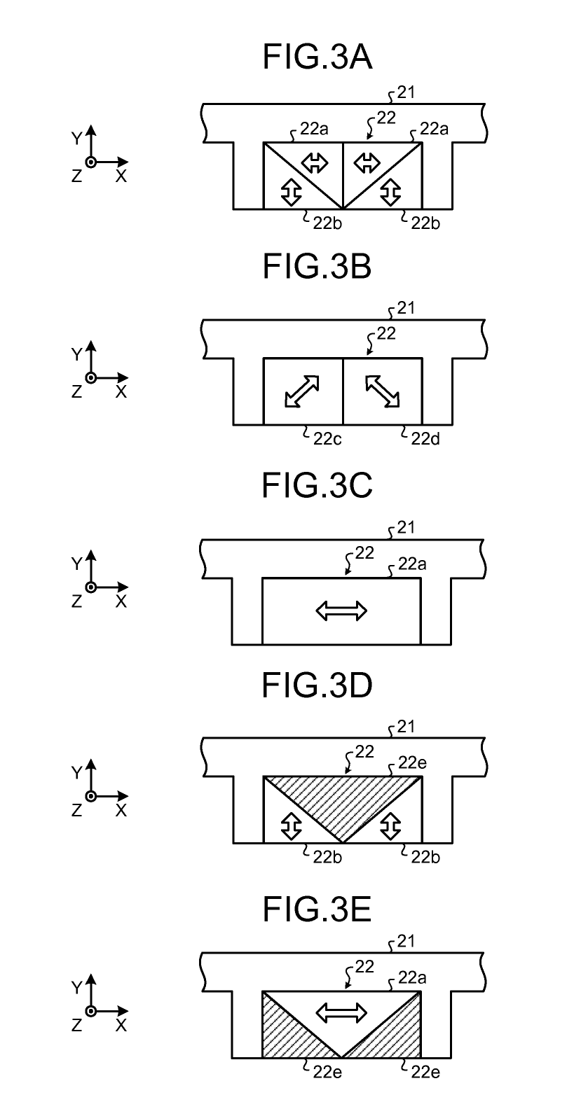

Meanwhile, it has been explained in FIGS. 1A and 1B that the magnetic segment 22 is constituted by the one directivity member 22a and the two directivity members 22b. However, the configuration of the magnetic segment 22 is not limited to this example. Therefore, alternative examples of the magnetic segment 22 are explained below with reference to FIGS. 3A to 3E.

FIG. 3A is a diagram illustrating an alternative example (1) of the magnetic segment 22 according to the first embodiment. As illustrated in FIG. 3A, the magnetic segment 22 according to the alternative example (1) includes the two directivity members 22a of which the magnetization directions are parallel to X-axis and the two directivity members 22b of which the magnetization directions are parallel to Y-axis.

In this case, the directivity members 22a illustrated in FIG. 3A are obtained by bisecting the directivity member 22a illustrated in FIG. 1A by using a plane parallel to the YZ plane (see FIG. 1A). In other words, the magnetic segment 22 illustrated in FIG. 3A is constituted by four triangular prisms.

In the case of FIG. 3A, a magnetic flux generated from the mover 10 (see FIG. 1A) returns to the mover 10 (see FIG. 1A) by way of a route according to the magnetization directions of the directivity member 22b, the directivity member 22a, the directivity member 22a, and the directivity member 22b.

FIG. 3B is a diagram illustrating an alternative example (2) of the magnetic segment 22 according to the first embodiment. As illustrated in FIG. 3B, the magnetic segment 22 according to the alternative example (2) includes: a directivity member 22c of which the magnetization direction has a predetermined angle (angle larger than zero degree and smaller than 90 degrees) with respect to the positive direction of X-axis on the XY plane; and a directivity member 22d of which the magnetization direction is obtained by reversing the magnetization direction of the directivity member 22c with respect to the YZ plane.

In the case of FIG. 3B, a magnetic flux generated from the mover 10 (see FIG. 1A) returns to the mover 10 (see FIG. 1A) by way of a route according to the magnetization directions of the directivity member 22c and the directivity member 22d.

FIG. 3C is a diagram illustrating an alternative example (3) of the magnetic segment 22 according to the first embodiment. As illustrated in FIG. 3C, the magnetic segment 22 according to the alternative example (3) includes the one directivity member 22a of which the magnetization direction is parallel to X-axis.

In the case of FIG. 3C, a magnetic flux generated from the mover 10 (see FIG. 1A) returns to the mover 10 (see FIG. 1A) by way of a convex portion of the non-magnetic holder 21, a route according to the magnetization direction of the directivity member 22a, and a convex portion of the non-magnetic holder 21.

As illustrated in FIGS. 3A, 3B, and 3C, the number of the directivity members is not limited to three. Therefore, the number of the directivity members can be any number. Moreover, the cross sectional shape obtained by cutting a directivity member by a plane parallel to the XY plane is not limited to a triangle. Therefore, the cross sectional shape may be a square, a rectangle, or a pentagon.

Meanwhile, it has been explained in FIGS. 3A, 3B, and 3C that the magnetic segment 22 is constituted by only one or only several directivity members. However, the magnetic segment 22 may be constituted by a directivity member and a non-directivity member. Therefore, the magnetic segment 22 including a non-directivity member is explained below with reference to FIGS. 3D and 3E.

FIG. 3D is a diagram illustrating an alternative example (4) of the magnetic segment 22 according to the first embodiment. The magnetic segment 22 illustrated in FIG. 3D is similar to the magnetic segment 22 illustrated in FIG. 1A except that the directivity member 22a illustrated in FIG. 1A is replaced by a non-directivity member 22e.

In the case of FIG. 3D, a magnetic flux generated from the mover 10 (see FIG. 1A) goes through the non-directivity member 22e in accordance with the magnetization direction of the directivity member 22b and returns to the mover 10 (see FIG. 1A) in accordance with the magnetization direction of the directivity member 22b.

FIG. 3E is a diagram illustrating an alternative example (5) of the magnetic segment 22 according to the first embodiment. The magnetic segment 22 illustrated in FIG. 3E is similar to the magnetic segment 22 illustrated in FIG. 1A except that the two directivity members 22b illustrated in FIG. 1A are replaced by the non-directivity members 22e.

In the case of FIG. 3E, a magnetic flux generated from the mover 10 (see FIG. 1A) goes through the non-directivity member 22e, goes through the non-directivity member 22e in accordance with the magnetization direction of the directivity member 22a, and returns to the mover 10 (see FIG. 1A).

As illustrated in FIGS. 3D and 3E, even if a magnetic segment partially employs a directivity member, the route of a magnetic flux is further restricted compared to a magnetic segment including only a non-directivity member. Therefore, cancelling between magnetic fluxes and non-return phenomenon of magnetic fluxes can be reduced.

As described above, the linear reluctance motor according to the first embodiment includes: a mover that has a plurality of magnetic poles on which coils are wound; and a stator in which magnetic segments including directivity members of which the magnetization directions are regulated in predetermined directions are embedded into a non-magnetic holder.

In this way, because at least a part of a magnetic segment employs a directivity member, the degradation of a magnetic flux passing through the magnetic segment can be prevented. Therefore, according to the linear reluctance motor of the first embodiment, a sufficient thrust can be obtained without increasing the size of a motor.

In the first embodiment described above, it has been explained that a primary side for generating a magnetic field is a mover and a secondary side magnetized by the magnetic field is a stator. However, the embodiment is not limited to this. The embodiment may have a configuration that a primary side for generating a magnetic field is a stator and a secondary side magnetized by the magnetic field is a mover. Even when such a configuration is employed, the same effect as that of the first embodiment can be obtained.

Although a linear reluctance motor has been explained as the first embodiment, the same content can be applied to a rotary reluctance motor. Therefore, a rotary reluctance motor is explained below as a second embodiment.

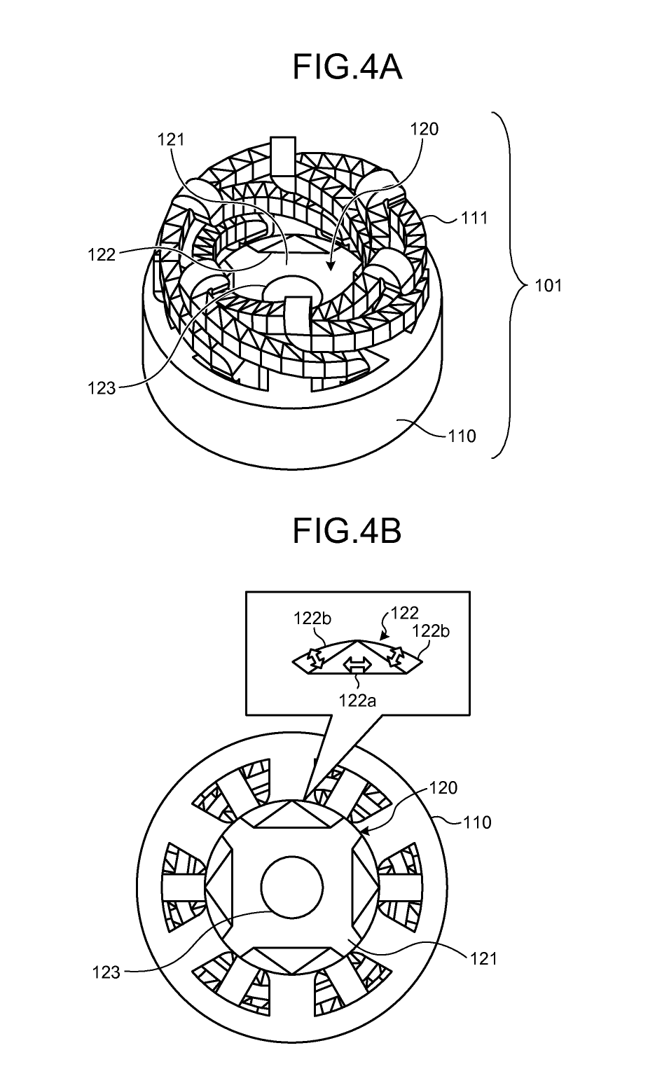

First, a reluctance motor according to the second embodiment is explained with reference to FIGS. 4A and 4B. FIG. 4A is a perspective view of a reluctance motor 101 according to the second embodiment. FIG. 4B is a front view of the reluctance motor 101 according to the second embodiment.

As illustrated in FIG. 4A, the reluctance motor 101 according to the second embodiment includes a rotor 120 and a stator core 110 on which coils 111 are wound. The stator core 110 has a plurality of magnetic poles (six poles in FIG. 4A) that protrudes toward the rotor side and has a distributed winding type in which the coils 111 are wound over the plurality of magnetic poles.

The distributed-winding type is suitable to raise an inductance torque but has a shape in which the coils 111 protrude toward the backside (the upper side of FIG. 4A) of the reluctance motor 101 as illustrated in FIG. 4A. Herein, the distributed-winding reluctance motor 101 is illustrated in FIG. 4A. However, the reluctance motor 101 may have a concentrated-winding type in which a coil is wound on each magnetic pole.

As illustrated in FIG. 4A, the rotor 120 includes a non-magnetic rotor 121 and a plurality of magnetic segments 122. Moreover, a shaft 123 is provided in the center of the non-magnetic rotor 121. Herein, the magnetic segments 122 are arranged on the outer circumferential surface of the non-magnetic rotor 121 at regular intervals (four segments in FIGS. 4A and 4B).

The reluctance motor 101 illustrated in FIGS. 4A and 4B has the configuration that the number of magnetic poles of the stator is six and the number of magnetic segments of the rotor is four. However, the number of magnetic poles and the number of magnetic segments may be different numbers.

Herein, the magnetic segment 122 corresponds to the magnetic segment 22 of the reluctance motor 1 according to the first embodiment. In other words, at least a part of the magnetic segment 122 of the reluctance motor 101 according to the second embodiment includes a directivity member.

For example, as illustrated in FIG. 4B, the magnetic segment 122 includes at the shaft side one directivity member 122a of which the magnetization direction is parallel to the outer circumferential direction (hereinafter, “circumferential direction”) of the rotor 120.

The magnetic segment 122 illustrated in FIG. 4B further includes at the outer circumferential side two directivity members 122b of which the magnetization directions are parallel to the normal directions of an outer circumference (hereinafter, “normal direction”) of the non-magnetic rotor 121. Herein, the magnetization direction of each directivity member is indicated with “white-space double-headed arrows” similarly to the case of the first embodiment.

As illustrated in FIG. 4B, a magnetic flux generated from the stator core 110 returns to the stator core 110 by way of the directivity member 122b of which the magnetization direction is parallel to its normal direction, the directivity member 122a of which the magnetization direction is parallel to the circumferential direction, and the directivity member 122b of which the magnetization direction is parallel to its normal direction.

In this way, because at least a part of the magnetic segment 122 employs a directivity member, the degradation of a magnetic flux passing through the magnetic segment 122 can be prevented. Therefore, according to the reluctance motor 101 of the second embodiment, a sufficient torque can be obtained without increasing the size of a motor.

It has been explained in FIGS. 4A and 4B that the magnetic segment 122 is constituted by the one directivity member 122a and the two directivity members 122b. However, similarly to the case of the first embodiment, the configuration of the magnetic segment 122 is not limited to this example.

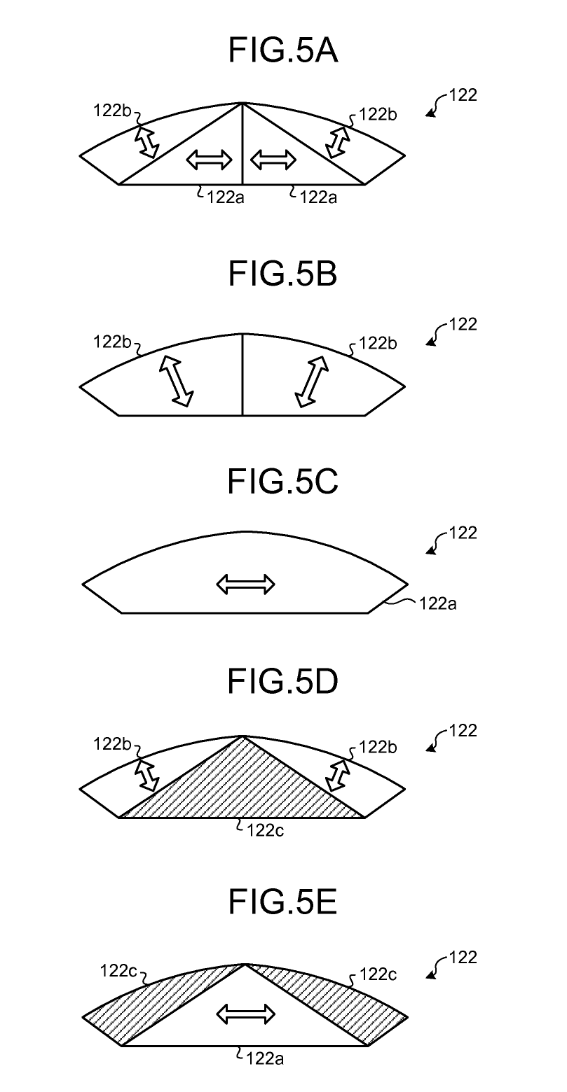

Therefore, alternative examples of the magnetic segment 122 are explained below with reference to FIGS. 5A to 5E. Because FIG. 5A to 5E respectively correspond to FIGS. 3A to 3E that are explained in the first embodiment, the overlapping explanation is omitted.

FIG. 5A is a diagram illustrating an alternative example (1) of the magnetic segment 122 according to the second embodiment. As illustrated in FIG. 5A, the directivity members 122a according to the alternative example (1) are obtained by bisecting the directivity member 122a illustrated in FIG. 4B by using its normal line. In other words, the magnetic segment 122 illustrated in FIG. 5A is constituted by four prism-like members.

In the case of FIG. 5A, a magnetic flux generated from the stator side returns to the stator side by way of a route along the magnetization directions of the directivity member 122b, the directivity member 122a, the directivity member 122a, and the directivity member 122b.

FIG. 5B is a diagram illustrating an alternative example (2) of the magnetic segment 122 according to the second embodiment. As illustrated in FIG. 5B, the magnetic segment 122 according to the alternative example (2) includes the two directivity members 122b of which the magnetization directions are parallel to the respective normal directions.

In the case of FIG. 5B, a magnetic flux generated from the stator side goes through the non-magnetic rotor 121 in accordance with the magnetization direction of the directivity member 122b and returns to the stator side in accordance with the magnetization direction of the directivity member 122b.

FIG. 5C is a diagram illustrating an alternative example (3) of the magnetic segment 122 according to the second embodiment. As illustrated in FIG. 5C, the magnetic segment 122 according to the alternative example (3) includes the one directivity member 122a of which the magnetization direction is parallel to its circumferential direction.

In the case of FIG. 5C, a magnetic flux generated from the stator side returns to the stator side by way of a convex portion of the non-magnetic rotor 121, a route according to the magnetization direction of the directivity member 122a, and a convex portion of the non-magnetic rotor 121.

FIG. 5D is a diagram illustrating an alternative example (4) of the magnetic segment 122 according to the second embodiment. The magnetic segment 122 illustrated in FIG. 5D is similar to the magnetic segment 122 illustrated in FIG. 4B except that the directivity member 122a illustrated in FIG. 4B is replaced by a non-directivity member 122c.

In the case of FIG. 5D, a magnetic flux generated from the stator side goes through the non-directivity member 122c in accordance with the magnetization direction of the directivity member 122b and returns to the stator side in accordance with the magnetization direction of the directivity member 122b.

FIG. 5E is a diagram illustrating an alternative example (5) of the magnetic segment 122 according to the second embodiment. The magnetic segment 122 illustrated in FIG. 5E is similar to the magnetic segment 122 illustrated in FIG. 4B except that the two directivity members 122b illustrated in FIG. 4B are replaced by the non-directivity members 122c.

In the case of FIG. 5E, a magnetic flux generated from the stator side goes through the non-directivity member 122c, goes through the non-directivity member 122c in accordance with the magnetization direction of the directivity member 122a, and returns to the stator side.

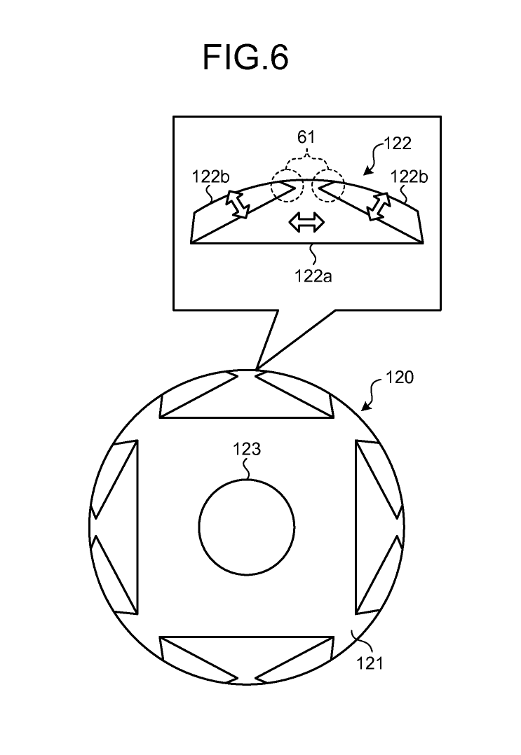

Next, another alternative example of the magnetic segment 122 is explained with reference to FIG. 6. FIG. 6 is a diagram illustrating an alternative example (6) of the magnetic segment 122 according to the second embodiment. FIG. 6 also corresponds to a diagram that is obtained by extracting only the rotor 120 from the front view illustrated in FIG. 4B.

As illustrated in FIG. 6, the magnetic segment 122 according to the alternative example (6) includes a hook-shaped portion 61 that is provided on the outer circumferential end of the directivity member 122a of which the magnetization direction is parallel to its circumferential direction. Due to the portion 61, the directivity member 122a can hold down the directivity members 122b of which the magnetization directions are parallel to their normal directions.

Therefore, according to the magnetic segment 122 illustrated in FIG. 6, parts that constitute the magnetic segment 122 can be prevented from protruding due to a centrifugal force by a rotation or an attractive force by the stator side. It has been explained that the magnetic segment 122 illustrated in FIG. 6 corresponds to the magnetic segment 122 illustrated in FIG. 4B. The hook-shaped portion 61 can be similarly applied to the magnetic segment 122 of FIGS. 5A, 5D, and 5E.

Because the shape of the magnetic segment 122 illustrated in FIG. 6 is a trapezoid in which the outer circumferential side is narrower than the shaft side, the parts that constitute the magnetic segment 122 do not protrude easily.

As described above, the rotary reluctance motor according to the second embodiment includes: a stator that has a plurality of magnetic poles on which coils are wound; and a rotor in which magnetic segments including directivity members of which the magnetization directions are regulated in predetermined directions are embedded into a non-magnetic rotor (corresponding to non-magnetic holder).

In this way, because at least a part of the magnetic segment employs a directivity member, the degradation of a magnetic flux passing through the magnetic segment can be prevented. Therefore, according to the rotary reluctance motor of the second embodiment, a sufficient torque can be obtained without increasing the size of a motor.

In the second embodiment described above, it has been explained that a primary side for generating a magnetic field is a stator and a secondary side magnetized by the magnetic field is a rotor. However, the embodiment is not limited to this. The embodiment may have a configuration that a primary side for generating a magnetic field is a rotor and a secondary side magnetized by the magnetic field is a stator. Even when such a configuration is employed, the same effect as that of the second embodiment can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reluctance motor comprising:
a stator; and
a mover,
one of the stator and the mover including a plurality of magnetic poles on which coils are wound, and
the other of the stator and the mover including a magnetic segment that includes a directivity member of which a magnetization direction is regulated in a predetermined direction and that is embedded into a non-magnetic holder.

2. The reluctance motor according to claim 1, wherein
the magnetic segment includes a plurality of directivity members of which magnetization directions are different, and
the magnetic segment forms a route through which a magnetic flux flowing in from a surface that does not contact the non-magnetic holder flows out to the surface in accordance with a combination of the directivity members.

3. The reluctance motor according to claim 1, wherein the magnetic segment further includes a non-directivity member of which a magnetization direction is not regulated.

4. The reluctance motor according to claim 2, wherein the magnetic segment further includes a non-directivity member of which a magnetization direction is not regulated.

5. The reluctance motor according to claim 1, wherein
one of the stator and the mover includes the plurality of magnetic poles that is linearly arranged at a predetermined interval,
the other of the stator and the mover includes a plurality of magnetic segments that is linearly embedded into the non-magnetic holder at a predetermined interval, and
the stator and the mover are arranged in such a manner that the magnetic poles and the magnetic segments face each other.

6. The reluctance motor according to claim 2, wherein
one of the stator and the mover includes the plurality of magnetic poles that is linearly arranged at a predetermined interval,
the other of the stator and the mover includes a plurality of magnetic segments that is linearly embedded into the non-magnetic holder at a predetermined interval, and
the stator and the mover are arranged in such a manner that the magnetic poles and the magnetic segments face each other.

7. The reluctance motor according to claim 3, wherein
one of the stator and the mover includes the plurality of magnetic poles that is linearly arranged at a predetermined interval,
the other of the stator and the mover includes a plurality of magnetic segments that is linearly embedded into the non-magnetic holder at a predetermined interval, and
the stator and the mover are arranged in such a manner that the magnetic poles and the magnetic segments face each other.

8. The reluctance motor according to claim 4, wherein
one of the stator and the mover includes the plurality of magnetic poles that is linearly arranged at a predetermined interval,
the other of the stator and the mover includes a plurality of magnetic segments that is linearly embedded into the non-magnetic holder at a predetermined interval, and
the stator and the mover are arranged in such a manner that the magnetic poles and the magnetic segments face each other.

9. The reluctance motor according to claim 1, wherein
one of the stator and the mover includes the plurality of magnetic poles that is arranged in a circumferential direction at a predetermined interval,
the other of the stator and the mover includes a plurality of magnetic segments that is embedded into the non-magnetic holder in a circumferential direction at a predetermined interval, and
the stator and the mover are arranged in such a manner that the magnetic poles and the magnetic segments face each other.

10. The reluctance motor according to claim 2, wherein
one of the stator and the mover includes the plurality of magnetic poles that is arranged in a circumferential direction at a predetermined interval,
the other of the stator and the mover includes a plurality of magnetic segments that is embedded into the non-magnetic holder in a circumferential direction at a predetermined interval, and
the stator and the mover are arranged in such a manner that the magnetic poles and the magnetic segments face each other.

11. The reluctance motor according to claim 3, wherein
one of the stator and the mover includes the plurality of magnetic poles that is arranged in a circumferential direction at a predetermined interval,
the other of the stator and the mover includes a plurality of magnetic segments that is embedded into the non-magnetic holder in a circumferential direction at a predetermined interval, and
the stator and the mover are arranged in such a manner that the magnetic poles and the magnetic segments face each other.

12. The reluctance motor according to claim 4, wherein
one of the stator and the mover includes the plurality of magnetic poles that is arranged in a circumferential direction at a predetermined interval,
the other of the stator and the mover includes a plurality of magnetic segments that is embedded into the non-magnetic holder in a circumferential direction at a predetermined interval, and
the stator and the mover are arranged in such a manner that the magnetic poles and the magnetic segments face each other.

13. The reluctance motor according to claim 9, wherein
the stator includes the plurality of magnetic poles that is arranged in an inner circumferential direction at a predetermined interval,
the mover includes the plurality of magnetic segments that is embedded into the non-magnetic holder in an outer circumferential direction at a predetermined interval,
each of the magnetic segments has a shape in which its outer circumferential side is narrower, and
at least one of parts that constitute the magnetic segment has a hook-shaped portion that engages with the other parts.

14. The reluctance motor according to claim 10, wherein
the stator includes the plurality of magnetic poles that is arranged in an inner circumferential direction at a predetermined interval,
the mover includes the plurality of magnetic segments that is embedded into the non-magnetic holder in an outer circumferential direction at a predetermined interval,
each of the magnetic segments has a shape in which its outer circumferential side is narrower, and
at least one of parts that constitute the magnetic segment has a hook-shaped portion that engages with the other parts.

15. The reluctance motor according to claim 11, wherein
the stator includes the plurality of magnetic poles that is arranged in an inner circumferential direction at a predetermined interval,
the mover includes the plurality of magnetic segments that is embedded into the non-magnetic holder in an outer circumferential direction at a predetermined interval,
each of the magnetic segments has a shape in which its outer circumferential side is narrower, and
at least one of parts that constitute the magnetic segment has a hook-shaped portion that engages with the other parts.

16. The reluctance motor according to claim 12, wherein
the stator includes the plurality of magnetic poles that is arranged in an inner circumferential direction at a predetermined interval,
the mover includes the plurality of magnetic segments that is embedded into the non-magnetic holder in an outer circumferential direction at a predetermined interval,
each of the magnetic segments has a shape in which its outer circumferential side is narrower, and
at least one of parts that constitute the magnetic segment has a hook-shaped portion that engages with the other parts.

17. A reluctance motor comprising:
a stator; and
a mover,
one of the stator and the mover including a plurality of magnetic poles on which coils are wound, and
the other of the stator and the mover including a magnetic segment that includes a regulating means of which a magnetization direction is regulated in a predetermined direction and that is embedded into a non-magnetic holder.
